(19) United States
(12) Patent Application Publication
(10) Pub. No.: US 2018/0240352 A1
(43) Pub. Date: Aug. 23, 2018

(54) Method and system of educational assessment

(71) Applicant: Jawahar Karreddula Thomas, Glenwood (AU)

(72) Inventor: Jawahar Karreddula Thomas, Glenwood (AU)

(21) Appl. No.: 15/189,010

(22) Filed: Jun. 22, 2016

(30) Foreign Application Priority Data
Jun. 24, 2015 (AU) 2015902443
Jan. 29, 2016 (AU) 2016900259
Apr. 1, 2016 (AU) 2016100353

(51) Int. Cl. G09B 7/02; G09B 5/12; G06F 17/27

(52) U.S. Cl. CPC G09B 7/02; G06F 17/278; G09B 5/12

(57) ABSTRACT

There is disclosed a computer implemented method for educational assessment of a first user using textural input data associated with the first user and response data provided by a second user in response to a pre-determined assessment. A computer system, a server, and a client terminal configured to perform such a method are also disclosed along with variations of the above-mentioned method.

### RELATED APPLICATIONS

This application claims priority from Australian provisional patent applications nos. 2015901204 filed on 4 Apr. 2015, 2015902443 filed 24 Jun. 2015 and 2016900259 filed 29 Jan. 2016, the contents which are incorporated herein by reference.

### TECHNICAL FIELD

The invention relates to a method for educational assessment. In particular, the method relates to a computer-implemented method and computer system for assessing a response from a user in relation to a pre-determined assessment scenario such as that required for training a doctor or other professional.

### BACKGROUND

In education and training a person learning is often subject to a series of assessments to determine the competency of the person. For example, during a learning exercise the person may be presented with a series of questions and then that person writes an appropriate set of answers that is then marked or scored by a tutor or examiner at a later time.

In training for professionals such as training to be a doctor, lawyer or engineer the person training may be provided with a problem or issue that needs to be addressed. For example, in medical training, the person may be presented with a patient that presents with one or more symptoms such as a headache or fever. The person then needs to make an assessment and diagnosis of the patient such as by exploring medical history, undertaking a physical examination, ordering relevant investigations and finally making an assessment and providing possible diagnoses.

The keeping of records such as file notes is an important part of these professions and good record keeping is important for doctors, lawyers and engineers. Accordingly, during training and in later professional practice it is important that adequate notes are taken that include, as for example in the medical profession, the patient history, patient examination and assessment, diagnosis and patient management.

In particular, it is important that the person in training and professional has treated the problem or issue in line with best practice that often requires the full exploration of the problem. For example, a patient may present with a headache and it would be expected that the person training or doctor would record the main symptom, make history notes, such as “patient headache for 3 days” and make notes about the physical or verbal assessment of the patient such as “headache present around forehead”.

However, importantly, the person training or doctor also needs to also consider that possible related illnesses, such as life-threatening illnesses, are not present, and as such it best practice to also note the ruling out of these related illnesses. For example, “stiffness in neck not present” and therefore “meningitis not likely”. The quality and consistency of the notes and considerations made by the person training or professional is important to demonstrate professional competency and also in possible negligence situations whereby the notes or records are required.

A problem that occurs during training, continuing education and professional practice is that the records kept by the professional may be inadequate, degrade in quality over time, and may not reflect best practice. Another problem that occurring during training, continuing education and professional practice is the ability for a third party, such as an examiner, to rapidly, cost-effectively and accurately determine competency based on such notes and records.

In addition to the keeping of good records, the competency of a doctor or professional is important. In particular, during a patient interview the doctor or typically asks a patient a series of questions such as, for example, questions about the patient's history or particular medical concern. Accordingly, the questions the doctor or professional asks, or does not ask, are important to arrive at the correct outcome such as a diagnoses or ongoing patient management.

A problem that occurs during training, continuing education and professional practice is that the correct questions to the patient or client may not be asked.

The invention disclosed herein seeks to overcome one or more of the above-identified problems or at least provide a useful alternative.

### SUMMARY

The invention disclosed herein seeks to provide a computer implemented method and system that provides an automated process for gathering evidence to assess clinical skills competency to assess and score a persons, such as a medical student's, clinical competence.

In one example, the computer implemented method and system utilise a competency framework approach that will significantly reduce training time, assessment effort, and hence increasing workforce flexibility to meet the accreditation and assessment functions of Australian Medical Council.

In a more specific example, the computer implemented method and system are configured to operate a method for clinical skills assessment of a medical student role playing as a doctor. In particular, the method involves software hosted by a server, accessible via Internet networking. The software includes an intelligence, scoring and analytics engine to assess the breadth and depth of a student's skill such as History Taking, Physical Examination, Investigation and Management, after taking an appropriate history from another medical student role playing as a patient.

In accordance with a first aspect there is provided, a computer implemented method for educational assessment of a first user using textural input data associated with the first user and response data provided by a second user in response to a pre-determined assessment, the method including the steps of: Receiving, via a computer system, textural input data associated with the first user in relation to the pre-determined assessment, Receiving, via the computer system, response data from the second user in relation to the pre-determined assessment, Processing, via the computer system, the textural input data to determine a set of textural features and comparing the set of textural features with a set of pre-determined textural features associated with the pre-determined assessment so as to provide textural comparison data; Processing, via the computer system, the response data by comparing the response data with pre-determined response reference data associated with the pre-determined assessment so as to provide response comparison data; Calculating, via the computer system, first results data indicating the similarity of the textual features and the pre-determined textural features based on the textural comparison data, and calculating second results data indicating the similarity of the response data and the pre-determined response reference data; and Providing, via the computer system, score data configured to indicate the at least one of the first results data, the second results data and a combination of the first and second results data.

In an aspect, the method includes the steps of: Providing, via the computer system, first assessment prompt data to the first user in relation to the pre-determined assessment, and Providing, via the computer system, second assessment prompt data to the second user associated with the pre-determined assessment, and wherein the first assessment prompt data includes a pre-determined assessment scenario upon which the first user is able to base questions communicable with the second user, and wherein the second assessment prompt data includes a series of answers associated with the pre-determined assessment scenario, the series of answers being selectable by the second user in response to the questions of the first user so as to provide the response data, and wherein textural input data is provided by at least one of user inputted text by the first user in response to the series of answers, predetermined text associated with the series of answers of the response data and a combination of user inputted text and the predetermined text.

In another aspect, the method further includes the steps of: Processing, via the computer system, the textural features to identify one or more sentences and keywords associated with each of the one or more sentences, and Comparing, via the computer system, the keywords associated with each of the one or more sentences with one or more pre-determined main criteria keywords and associated one or more pre-determined decision based keywords to determine similarity data indicative of the presence of the one or more pre-determined main criteria keywords and the associated one or more of the pre-determined decision based keywords in the identified one or more sentences; Calculating, via the computer system, first results data based on the similarity data.

In accordance with a second aspect there is provided, a computer system for educational assessment of a first user using textural input data associated with the first user and response data provided by a second user in response to a pre-determined assessment, the computer system being configurable to: Receive, via the computer system, textural input data associated with the first user in relation to the pre-determined assessment, Receive, via the computer system, response data from the second user in relation to the pre-determined assessment, Process, via the computer system, the textural input data to determine a set of textural features and comparing the set of textural features with a set of pre-determined textural features associated with the pre-determined assessment so as to provide textural comparison data; Process, via the computer system, the response data by comparing the response data with pre-determined response reference data associated with the pre-determined assessment so as to provide response comparison data; Calculate, via the computer system, first results data indicating the similarity of the textual features and the pre-determined textural features based on the textural comparison data, and calculating second results data indicating the similarity of the response data and the pre-determined response reference data; and Provide, via the computer system, score data configured to indicate the at least one of the first results data, the second results data and a combination of the first and second results data.

In accordance with a third aspect there is provided, at least one of a client terminal and a server configured to operate with or within a computer system as defined above.

In accordance with a fourth aspect there is provided, a computer implemented method for educational assessment of user generated textural input data provided in response to a pre-determined assessment, the method including the steps of: Receiving, via the computer system, the user generated textural input data in relation to the pre-determined assessment; Processing, via the computer system, the user generated textural input data to identify sentences and keywords associated with the identified sentences; Comparing, via the computer system, the keywords associated with each identified sentences with one or more main criteria keywords and one or more decision based keywords associated with the one or more main criteria keywords so as to determine similarity data indicative the presence of the one or more pre-determined main criteria keywords and the associated one or more pre-determined decision based keywords in each of the identified sentences, the one or more pre-determined main criteria keywords and one or more pre-determined decision based keywords being loaded from predetermined reference data; and Calculating, via the computer system, results data based on the similarity data indicating a similarity between the user generated textural input data and the predetermined reference data.

In accordance with a fifth aspect there is provided, a computer implemented method for educational assessment of user generated textural input data provided in response to a pre-determined assessment, the method including the steps of: Receiving the user generated textural input data in relation to the pre-determined assessment; Processing the user generated textural input data to determine set of user generated textural features including at least one of a user generated keyword, phrase and sentence; Comparing the set of user textural features with a set of pre-determined textural features including at least one of a pre-determined generated keyword, phrase and sentence derived from pre-determined reference data associated with the pre-determined assessment so as to generate textural comparison data; and Calculating results data including score data indicating the similarity of the set of user generated textural features with the pre-determined textural features based on the textural comparison data.

In one aspect, the user generated textural features include a set of user-generated keywords, and the pre-determined textural features include a set of pre-determined keywords derived from the pre-determined reference data.

In another aspect, the user generated textural input data is associated with one or more pre-determined assessment categories, and wherein the user generated textural input data is compared with the pre-determined set of keywords associated with the same one or more pre-determined categories such that textural comparison data is provided for each of the one or more pre-determined categories.

In yet another aspect, the pre-determined assessment includes one or more assessment categories, and wherein the user generated keywords and the pre-determined keywords are associated with a respective one or more of the assessment categories so as to allow category wise assessment.

In yet another aspect, the pre-determined keywords include one or more pre-determined main criteria keywords, and wherein the step of comparing includes determining if the pre-determined main criteria keywords are present in the user generated keywords.

In yet another aspect, the pre-determined keywords include pre-determined decision based keywords associated with the main criteria keywords, and wherein the step of comparing includes determining if the pre-determined decision based keywords are associated with the main criteria keywords.

In yet another aspect, the pre-determined decision based keywords includes pre-determined affirmative keywords and pre-determined negative keyword.

In yet another aspect, in the step of processing, the user generated textural input data, includes separating the user generated textural input data into identified sentences and identifying keywords associated with a particular once of the sentences.

In yet another aspect, in the step of comparisons, the user generated keywords in each sentence are compared with the pre-determined keywords to determine if one or more of the pre-determined keywords are present in the sentence.

In yet another aspect, in the pre-determined keywords include one or more main criteria keywords and one more or decision based keywords associated with the main criteria keywords, and wherein in the step of comparison the user-generated keywords in each sentence are compared to the one or more main criteria keywords and the associated one of more decision based keywords to determine the presence of the one or more main criteria keywords and the associated one of more decision based keywords in the identified sentence.

In yet another aspect, the user textual input data is processed to determine main criteria keywords and at least one of affirmative and negative keywords associated with the main criteria keywords, and wherein the step of comparing includes comparing the main criteria keywords and the associated affirmative and negative keywords with pre-determined reference data that has a reference set of criteria keywords and an associated reference set of affirmative and negative keywords associated with the reference set of criteria keywords.

In yet another aspect, the user generated textural input data is at least one of a voice recording convertible to computer readable text, a hand written response convertible to computer readable text and a keyboard inputted text.

In yet another aspect, the keyword operations include operation of one or more textural analysis algorithms.

In yet another aspect, keyword operations include the step of splitting the user generated textural input data into sentences.

In yet another aspect, the keyword operations include the step of performing n-gram analysis on sentences identified in the user generated textural input data.

In yet another aspect, results data includes display data suitable for displaying the score and associated pre-determined assessment information in at least one of a graph and chart.

In accordance with a sixth aspect there is provided, a computer readable medium adapted to be executable by a computer to perform a method for educational assessment of user generated textural input data in response to a pre-determined assessment, the method including the steps of: Receiving, the user generated textural input data, in relation to the pre-determined assessment data; Processing, the user generated textural input data, by performing keyword operations to determine a set of user generated keywords; Comparing the set of user generated keywords with a set of pre-determined keywords derived from pre-determined reference data associated with the pre-determined assessment so as to generate keyword comparison data; and Calculating results data including score data indicating the similarity of the set of user generated keywords with the pre-determined keywords based on the textural comparison data.

In accordance with a seventh aspect there is provided, a computer system for educational assessment of user generated textural input data in response to a pre-determined assessment, the system being configured to: Receive, at the system, the user generated textural input data, in relation to the pre-determined assessment data; Process, in a processor of the system, the user generated textural input data, by performing keyword operations to determine a set of user-generated keywords; Compare, in the processor of the system, the set of user generated keywords with a set of pre-determined keywords derived from pre-determined reference data associated with the pre-determined assessment so as to generate keyword comparison data; and Calculate, in the processor of the system, results data including score data indicating the similarity of the set of user generated keywords with the pre-determined keywords based on the textural comparison data; Display, via a display of the system, the results data.

In accordance with a eighth aspect there is provided, computer implemented method for educational assessment of user generated textural input data provided in response to a pre-determined assessment, the method including the steps of: Receiving the user generated textural input data in relation to the pre-determined assessment; Processing the user generated textural input data by performing keyword operations to determine a set of user generated keywords; Comparing the set of user generated keywords with a set of pre-determined keywords derived from pre-determined reference data associated with the pre-determined assessment so as to generate keyword comparison data; and Calculating results data including score data indicating the similarity of the set of user generated keywords with the pre-determined keywords based on the textural comparison data.

In accordance with a ninth aspect there is provided, a computer implemented method for educational assessment of a first user using textural input data provided by the first user and response data provided by a second user in response to a pre-determined assessment, the method including the steps of: Receiving, textural input data, from the first in relation to the pre-determined assessment; Receiving, response data, from the second user, the response data in relation to the pre-determined assessment. Processing the textural input data to determine set of user generated textural features including at least one of a user generated keyword, phrase and sentence and comparing the set of user textural features with a set of pre-determined textural features including at least one of a pre-determined generated keyword, phrase and sentence derived from pre-determined reference data associated with the pre-determined assessment so as to generate textural comparison data. Processing the response data by comparing the response data with pre-determined response reference data associated with the pre-determined assessment so as to generate response comparison data. Calculating first results data indicating the similarity of the set of user generated textural features with the pre-determined textural features based on the textural comparison data and calculating second results data indicating the similarity of the response data and the pre-determined response reference data, and Providing, score data, configured to indicate the at least one of the first results data, the second results data and a combination of the first and second results data.

In some specific aspects, the above described method and system may be carried out as a Method of Clinical Skills Assessment including: Role Play: Mimicking a real consultation between a doctor and a patient; Simulated Patient: Student, Role playing as a Patient; User: Student, Role playing as a Doctor; Complaint: Primary medical condition, say “Headache”; Case scenario: Narrowed down diagnosis of the primary medical condition, say “Tension Headache”. In general terms, the steps in this example, may be as follows:

Step 1: Simulated Patient will be provided with a random generated case history (or defined case history) and plays the role of a patient.

Step 2: The user being assessed asks a series of questions to determine the diagnosis of the primary complaint.

Step 3: The patient then provides a series of pre-determined responses and the user types in free-text based notes based on the response and gathered information, such a the undertaking of a mock physical examination. The notes are to reflect those typically required in all domains of a standard consultation which are History Taking, Physical Examination, Investigations and Management.

Step 4: The notes are then received by a business intelligence or assessment engine, operated by a server, which then breaks down the inputs in to their logical grouping and assess its accuracy with the current standards defined in the system. The standards are based on current best practice in the respective fields of medicine (e.g. General Practice, Medicine, Surgery, etc.).

Step 5: One of the key features is that the doctors notes typed by the user are scored by an intricate scoring engine that gives an instant report on the standard consultation namely History Taking, Physical Examination, Investigations and Management.

Step 6: The instant analytical report thus generated determines the competency as determined by current best practice in that particular medical field e.g. General practice, Surgery, Medicine etc. The analytical report also clearly describes the strengths and areas needing improvement in that particular simulated case scenario.

### BRIEF DESCRIPTION OF THE FIGURES

The invention is described, by way of non-limiting example only, by reference to the accompanying figures, in which;

FIGS. 1a and 1b are system diagrams illustrating an exemplary system for execution software to perform the herein disclosed methods;

FIG. 2a is a flow diagram illustrating a first example method for educational assessment;

FIG. 2b is a flow diagram illustrating an non-assisted and assisted version of the first example method for educational;

FIG. 2c is a flow diagram illustrating an example of the assisted version of the first example method for educational showing an example dialogue between a patient and role-playing doctor.

FIG. 3a is a flow diagram illustrating a Part 1 of second example method for educational assessment;

FIG. 3b is a flow diagram illustrating a Part 2 of second example method for educational assessment;

FIGS. 4a to 4c is flow diagram illustrating a further more detailed example of textural analysis that may be used by the method;

FIG. 5 is a screen view illustrating an example of consultation environment including assessment page having folders for assessment data, free-form notes inputted by the user for submission as well as folders for results data;

FIGS. 6a to 6d are flow diagrams illustrating an example of method of comparison and determining associated scoring output data; and

### DETAILED DESCRIPTION

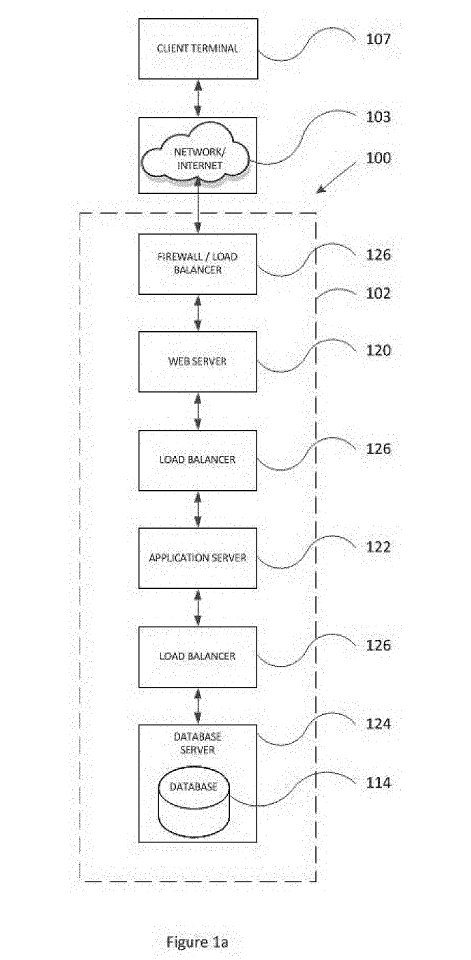

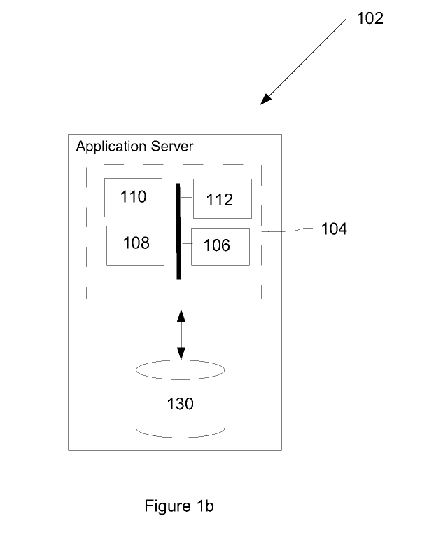

Referring to FIGS. 1a and 1b, there is illustrated an exemplary system 100 on which the present invention may be embodied. The system 100 includes a server system 102 configured, as is further described below, to provide and undertake educational assessments, based on inputted responses received from a user. The server system 102 is configured to communicate over a network 103, such as the Internet, within a variety with a client computing devices 107. The server system 102 may receive and transmit data for display at the client computing devices 107.

In this example, the server system or server cluster 102 may be provided as a server cluster arrangement including a webserver 120, an application server 122 and a database server 124. A load balancer and firewall 126 is arranged between the webserver 120 and the network 103 and the database server 124 includes a main database 114 such as an Oracle™ or MySQL™ database. The main database 114 stores assessment data and reference data as is further described below. In this configuration, a user is able to communicate with the server system 102 via the webserver 120 using the web enabled client device 107 to input, display and view data. Such web enabled client devices including personal computers, mobile smartphones, tablets etc to view and input data via a web browser or native client software.

It is noted in the above example a simplified server system 102 is described for brevity sake and the system 100 may also employ other configurations such as multiple distributed application server clusters, or even, in simple examples operate the entire system on a computing system or device having a single processor, database and interface. Other configurations will also be apparent to a person skilled in the art.

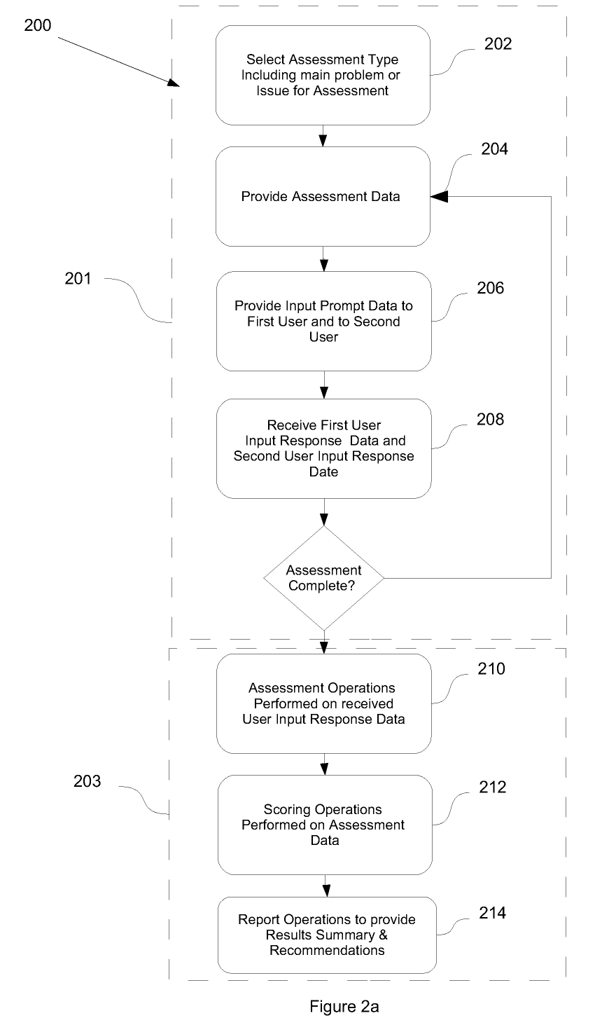

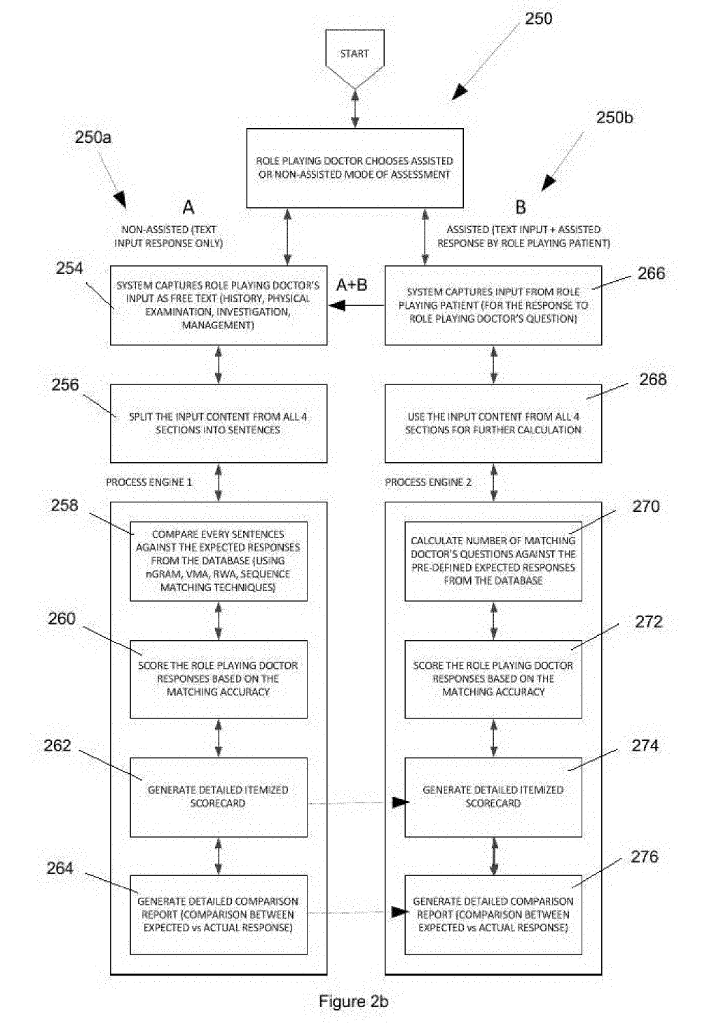

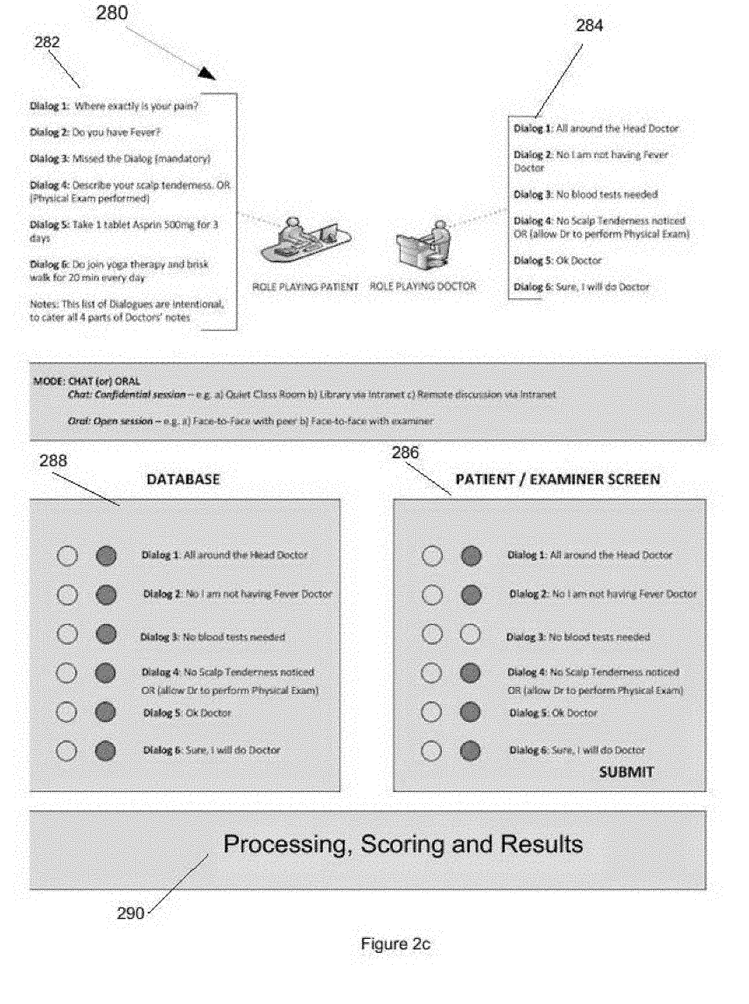

Referring now to FIG. 2, an example of the application server 122, which primarily executes the described methods herein, is provided. The application server 122 includes a computer device or system 104 including a processor 106, memory 108, a communications module 110 for communicating with the database server 124 and the web server 120, and an I/O module (I/O) 112 for communicating with I/O devices such as screens and keyboards. Other computing configurations may be utilised. The application server 122 may itself include a database 130. Alternately, the database 130 may be omitted the data may be received and communicated from the main database server 124.

The server 122 may include or be loaded with application software that is executed by the processor 106 to execute the methods described herein. The application software may be stored on the memory 108. The webserver 120 and database server 124 may include one ore more similarly configured computer devices or systems.

### First Example—Method of Education Assessment

Turning now to the methods of educational assessment provided and referring to FIG. 2 where the general method of education assessment 200 is described, in this case, an example is provided in relation to medical training and assessment of a user or student in response to information provided during a pre-determined assessment scenario.

The information provided to the user or student may include questions, comments or dialogue that is communicated to the user. In some examples, the user may be placed in a role-play scenario whereby a role-play partner or second user is provided with a pre-determined dialogue or questions from which the user bases their responses. The role-play partners or second user may be another person or a computer via textural display or computer-generated speech or computer generated video clips. In this example, the user and the second user are both provided with some kind of pre-determined information that the user may interpret and then form a response. This response provides user input textural data. The second user may also provide input data in response to pre-determined information provided to the second user.

The method of education assessment 200 includes a first or information collection stage 201 following by a second or information processing and reporting stage 203.

Turning firstly to the information collection stage, 201, at step 202 a general problem or topic is selected from the server 100, and at Step 204 assessment data is provided to the user or the user and partner in a role play scenario. The assessment data may be stored on the database 114 and communicated via the network 103 to the user. The selection of the problem or topic may be made by the user, an examiner or may be randomly selected from the database 114 by the server system 102.

The assessment data 204 may be provided to the user as a printable document for reading by the user and/or role-playing partners (as is common in the field of clinical medical training) or alternatively the assessment data 204 may be displayable on a computing device 107.

In this example, the main problem or topic may relate to the medical field in relation to a patient presenting with the main symptom of a headache or the like. However, there may be range of other main topics depending on specific assessment scenario. The assessment data 204 may include an identifier to associate the information provided to the user with the particular assessment.

The assessment data may include assessment categories that each include a series of sub-category questions that relate to main symptom. For example, the assessment categories may include a History Category such as taking a history of the patient, an Investigation Category such as investigations into the patent's aliment, a Physical Examination Category in relation to physical examination of the patient and a Management Category in relation to diagnosis and on-going treatment. Each assessment category includes assessment category specific questions or prompts that require input such as free-form written text and selection of pre-determined responses via check boxes, menu selections or the like.

The assessment data provided to the second user may include a series of predetermined responses to questions to should be asked by the user. The questions that are asked by the user may be asked orally or via a chat window so that the questions are remotely provided, and recordable, to the second user. For example, in the history category, the user should ask a series of questions from which the user may base notes in response to replies by the second user. The second user is provided with predetermined responses to the questions that should be asked in relation to the history category. An example of the predetermined responses provided to the second user is provided in FIG. 2c.

At Step 206, the user and second user are provided with input prompt data such as text boxes, radio buttons, selectable menus or the like that receive input data into the system 100 in response the pre-determined assessment data. At Step 208 the user and second user then provides user input data such as free-form typed text into the text boxes or makes selections of menus or radio buttons.

The input prompt data is associated with the assessment data such that the input prompt data is received within the same main categories and sub-categories as the questions or prompts provided in the assessment data. Therefore, the user and second user input data will be associated with the main problem, the categories and subcategories. This may be achieved by having identifiers that are unique to the particular assessment data provided, the user input data and the second user data thereby allowing the system 100 to link the assessment data to the user and second user input data.

The identifier may allow the system 100 to determine which category and subcategory to associated with the user or second user input response data which is important to allow the system 100 to perform the assessment tasks on the user input data. For example, the identifier may be used to link all assessment data relating to the category of history taking with user data in response to that particular assessment data. The data inputted by the second user may also be linked to the user so as to form part of the assessment of the user.

In some examples, the input prompt data may be provided to one or more computing devices that allow the collection of user input data in response the assessment data provided. The one or more computing devices then submit the input data to the system 100, more specifically the server system 102, for assessment.

Once the assessment information collection stage is complete the user input data, any associated second user data, and any associated identifiers are submitted or sent to the sever system 102 for the information processing and reporting stage 203 that is now further described below.

At step 210, the user and second user input data a received by the server system 102 that then performs assessment operations on the data by performing comparative data operations between the received user and second user input data and pre-determined response or reference data stored, preferably, in the database 114.

These operations include associating a particular user and second user input with the pre-determined response or reference data, such as by linking these via the identifier, and then a comparing the pre-determined response data and the user and second user input data and providing comparison data that may later be used to determine a score for the particular assessment. The user input data may include free-form text and the assessment operations may employ artificial intelligence type routines and algorithms, in particular, when assessing the free-form textural input from a user. However, it is noted that the response of the second user to the predetermined questions, via selectable buttons, or the like may be assessed by comparative database operations with a pre-determined answer set. Accordingly, in this example, the textural analysis forms only part of the overall assessment.

Such textural analysis may include natural language processing including n-gram analysis, VMA (Vocabulary and Morphological Analysis), RWA (Root Word Analysis), Sequence Matching, stemming and other available textural based analysis algorithms. The textural analysis methods are briefly outlined below and may be individual applied or applied in combination in the methods 200, 300, 400 and 600 disclosed herein.

In the fields of computational linguistics and probability, an n-gram is a contiguous sequence of n items from a given sequence of text or speech. The n-grams typically are collected from a text or speech corpus. When the items are words, n-grams may also be called shingles. An n-gram of size 1 is referred to as a “unigram”; size 2 is a “bigram” (or, less commonly, a “digram”); size 3 is a “trigram”. Larger sizes are sometimes referred to by the value of n, e.g., “four-gram”, “five-gram”, and so on as shown in Table 1.

TABLE 1

| | | | 1-gram | 2-gram | 3-gram |
|---|---|---|---|---|---|
| Field | Unit | Sample sequence | sequence | sequence | sequence |
| Vernacular | | | unigram | bigram | trigram |
| name | | | | | |
| Order of | | | 0 | 1 | 2 |
| resulting | | | | | |
| Markov model | | | | | |
| Protein | amino | ... Cys-Gly-Leu-Ser-Trp | ..., Cys, | ..., Cys- | ..., Cys- |
| sequencing | acid | ... | Gly, Leu, | Gly, Gly- | Gly-Leu, |
| | | | Ser, Trp, | Leu, Leu- | Gly-Leu- |
| | | | ... | Ser, Ser- | Ser, Leu- |
| | | | | Trp, ... | Ser-Trp, ... |
| DNA | base | ... AGCTTCGA ... | ..., A, G, | ..., AG, | ..., ACG, |
| sequencing | pair | | C, T, T, C, | GC, CT | GCT, CTT, |
| | | | G, A, ... | TT, TC, | TTC, TCG, |
| | | | | CG, GA, | CGA, ... |
| | | | | ... | |
| Computational | character | ... to_be_or_not_to_be ... | ..., t, o,_, | ..., to, | ..., to_, |
| linguistics | | | b, e, _, o, | o_, _b, be, | o_b, _be, be_, |
| | | | r, _, n, o, | e_, _o, or, | e_o, _or, |
| | | | t, _ t, o, | r_, _n, no, | or_, r_n, |
| | | | _, b, e, ... | ot, t_, | _no, not, |
| | | | | _t, to, | ot_, t_t, _to, |
| | | | | o_, _b, | to_, o_b, _be, |
| | | | | be, ... | ... |
| Computational | word | ... to be or not to be ... | ..., to, be, | ..., to be, | ..., to be or, |
| linguistics | | | or, not, to, | be or, or | be or not, or |
| | | | be, ... | not, not to, | not to, not to |
| | | | | to br, ... | be, ... |

Accordingly, using n-gram analysis the application server 122 may breakdown the user input data in the form of textural input into discrete sentences and further breakdown the sentences into one or more keywords.

RWA (Root Word Analysis) refers herein to linguistic morphology and information retrieval to reduce the words to its root. The stem needs not to be identical to the morphological root of the word; it is usually sufficient that related words map to the same stem, even if this stem is not in itself a valid root. For example, A stemmer for English, for example, should identify the string “cats” (and possibly “catlike”, “catty” etc.) as based on the root “cat”, and “stemmer”, “stemming”, “stemmed” as based on “stem”. A stemming algorithm reduces the words “fishing”, “fished”, and “fisher” to the root word, “fish”. On the other hand, “argue”, “argued”, “argues”, “arguing”, and “argus” reduce to the stem “argu” (illustrating the case where the stem is not itself a word or root) but “argument” and “arguments” reduce to the stem “argument”.

VMA (Vocabulary Morphological Analysis) is the process of grouping together the different inflected forms of a word so they can be analysed as a single item. It is a process of determining the lemma for a given word. This process may involve complex tasks such as understanding context and determining the part of speech of a word in a sentence.

Sequence matching is a Python library. This is a flexible library for comparing pairs of sequences of any type, so long as the sequence elements are hashable.

The ultimate result being a set of identified user inputted textural features such as keywords and sentences that may then be compared to a set of pre-determined textural features including pre-determined reference keywords and pre-determined reference sentences or phrases. An example of the textural analysis is provided in method 400. Typically, this include about 80% “keyword matching” and about 20% “sentence and/or phrase” matching. Other textural analysis methods may include complete phrase or sentence interpretations and the inclusion of dictionaries with customisation features to allow for pre-determined words, phrases or sentences to be matched.

Importantly, the set of pre-determined textural features such as keywords is associated with the particular assessment, main problem and categories, via an identifier or the like, to ensure the correct user textural features or keywords are compared against the correct associated set of pre-determined keywords.

The server system 102, more specifically the processor 106 application server 122, then determines textural comparison data that forms at least part the assessment data that is in turn ultimately used to score the assessment as is further detailed below. For example, an exact keyword match may return a numeric result of 1.00 whereas a partial match may result a numeric result or 0.75. The assessment data may also include numeric values in response to structured responses such as the selection of an answer from a menu of the like. For example, the assessment data from the second user includes numeric values in response to structured responses such as the selection of an answer from a menu of the like such as those shown in FIG. 2c. The assessment data may be stored in memory 108 or the database 114 for further processing. More detailed examples of the assessment operations are provided below.

At Step 212, scoring operations are undertaken in which the assessment data is further processed by the server system 102, more specifically the processor 106 application server 122, to provide scoring data. For example, the scoring operations may include the tally of assessment data, such as numeric keyword matching data, an the tally data resulting from the correct or incorrect answer to structured questions such as selection from menus or the like. In some examples, weighting may be used to give greater weight to assessment data from particular categories, subcategories or type of assessment data. A more specific example of processing the score data is provided in method 600 discuss below.

For example, in medical training, there may be an emphasis on note taking and therefore assessment data that arises from free-from text input may be weighted more heavily. Certain keywords or sentences may also carry greater weight, for example, there may be keywords or groups of keywords that are regarded as essential, and hence given a high score if present and a negative or low score if not present. In addition to a score for note taking, in this example, there may be an additional competency score associated with the responses from the second user to questions asked, or not asked, by the user during the assessment.

Ultimately, the scoring operations perform a series of data operations on the assessment data that results in a score for each the categories, for example a score for History, Investigation, Physical Examination and Management, that is reflective or indicative of the skill or competency of the user or question receiver.

At Step 214, the server system 102, more specifically the processor 106 application server 122, undertakes further reporting operations on the scoring data to provide results data suitable to be presented or displayed in a report either displayed on a screen or presented as a printable document. The report may include tabular or graphical representations of the scoring data. For example, a bar chart could be provided to show a % score for each of categories. The report may also include identifier data such as the user name, date of assessment and also include assessment information such as the subject of the assessment. Examples of the scoring are provided in method 600 below.

The databases 114 may include pre-determined results or reference data that may include a results actions or recommendation data associated with a particular score. For example, a low score in a particular category such as History, may trigger the results data including recommendation data that the user undergo further training in relation to patient history taking. Accordingly, when the results data is provided in the report, appropriate recommendations are also made specific to the category and thereby assisting toward the improvement of the skills or competency of the user.

### Example Method of Assessment—Non-Assisted and Assisted

Referring to FIG. 2b, an overview of a further method 250 of educational assessment is provided that substantially incorporates the steps of method 200 above that are not again repeated here for brevity. In practice, the methods herein may be implemented in a non-assisted format 250a and an assisted format 250b. In the non-assisted format 250a the first users textural input data is primarily based on free text notes inputted by the first user in response to questions asked by the first user and responses from the second user.

The assisted format 250b, however, provides textural input data based on the response data provided by the second user. As will be further detailed below with reference to FIG. 2c, the answers selected by the second user will have associated pre-determined textural date in the form of notes that auto-populate the textural input data of the first user (in essence—the system provides the notes for the first user). This provides the first user with a guide as to the required notes. However, the first user may amend or add to the auto-generated notes such as by adding additional free form text.

In more detail, at step 252 a first user who may be a role-playing doctor chooses one of the assisted method 250a and the non-assisted method 250b. Referring to the assisted method “A”, at step 254 the system 100 captures the role playing doctors input as free text in each of the four categories, in this example, being history, physical examination, investigation, management. The user inputted free text is then converted into sentences that are associated with each of the four assessment categories. The sentences which are identified with each of the four assessment categories are then submitted to a first processing engine that employs natural language processing to assess the free text input.

At step 258, each of the sentences, in particular keywords within the sentences, is compared against predetermined responses including predetermined sentences and predetermined keywords, stored in a reference database. The natural language processing may be used and is preferably selected from one of nGRAM analyses, VMA, RWA, and sequence matching techniques. These techniques are further detailed below.

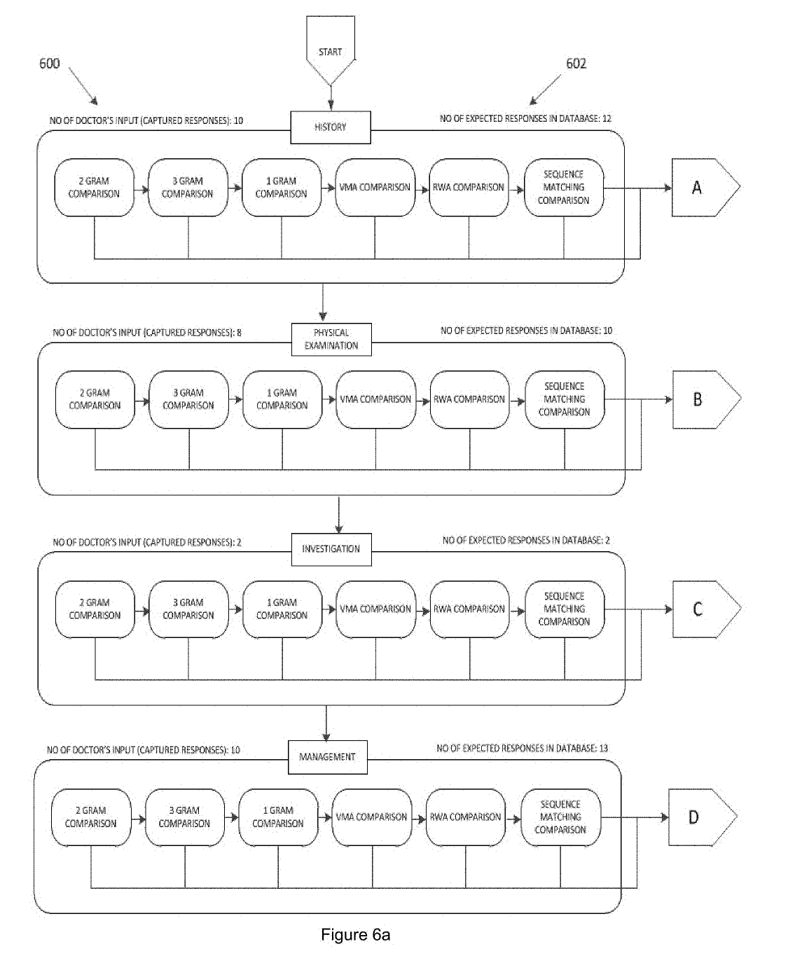

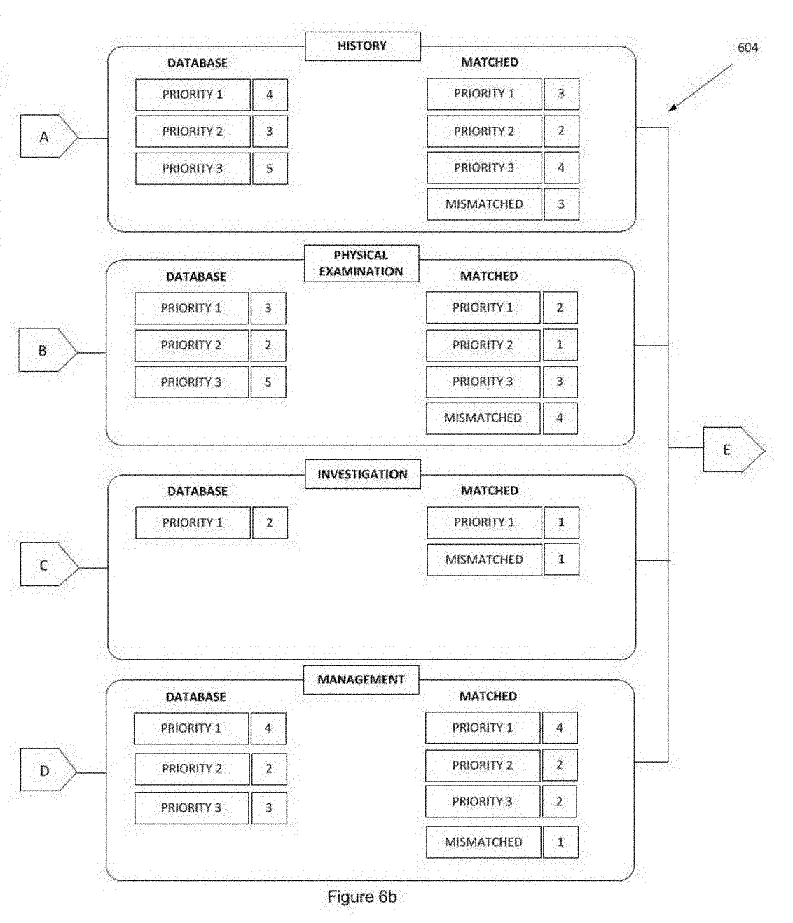

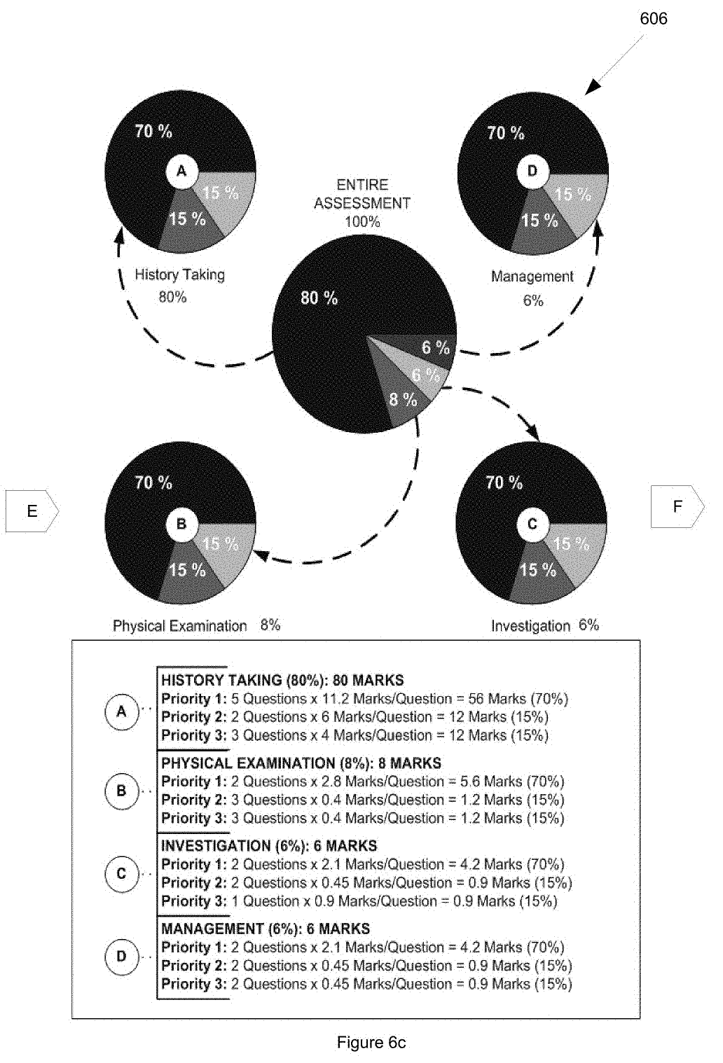

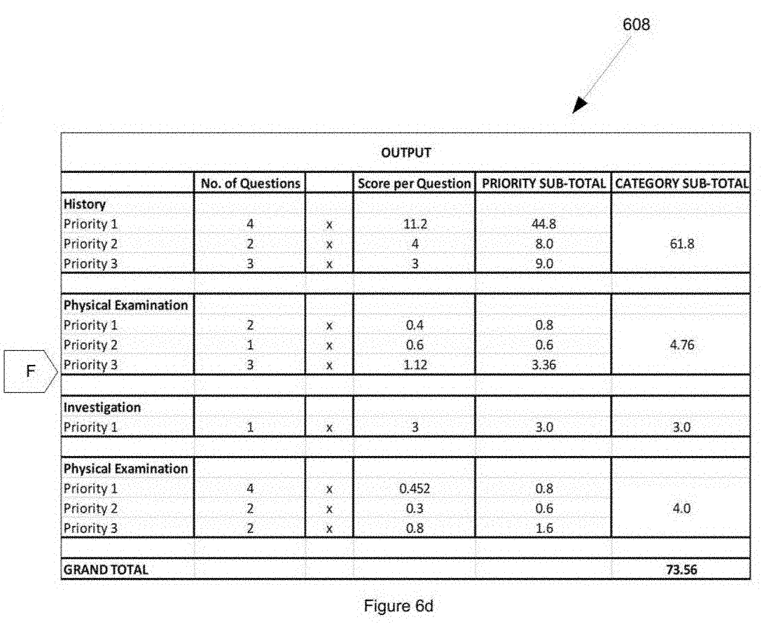

At step 260, the method includes scoring the role-playing doctor's responses based on the similarity between the sentences and keywords inputted by the role-playing doctor and the predetermined responses including predetermined sentences and predetermined keywords. At steps 262 and 264 a detailed itemised scorecard and comparison data is determined and an example of such a scorecard and comparison data is provided in FIG. 6c and FIG. 6d.

In this example, the assisted method 250b includes the provision for free form textural input as well as input responses from based on responses from the second user, in this example, a role-playing patient. The textural input data including any free form textual input from the first user is process via the non-assisted method 250a as indicated by the arrow “A+B”. However, the response data from the second user is captured by the system at step 266, as response data, that is also separated into the four categories, in this example, being history, physical examination, investigation, management. At step 270, the response data is processed by a second process engine that includes calculating the number of matching doctor's questions against the predefined expected responses from the database. At step 272, method then includes scoring the role-playing Dr's responses based on the matching accuracy.

At step 274 and 276 detailed itemised scorecards are provided along with a detailed comparison report that shows the differences between the expected and actual responses. It is noted that the results from process engine one are also available and may be compared to the results from process engine number two. This assists to determine any discrepancies that may exist between the processing and assessment of the doctors free-form notes and the assessment and processing and that is carried out on the response data. In particular, this may be important because the natural language processing may disadvantage some users and the response data, which is based on predetermined and structured responses, may be used to normalise the results from the natural language processing and at the same time provide a different perspective on the assessment.

A pictorial example of the assisted method 250b is provided below with reference to FIG. 2c.

### Example Method of Assessment—Assisted

Referring to FIG. 2c, this is shown an example block diagram 280 of a competency assessment that form part of the method for education assessment as described in methods 200 and 300.

In this method, the system 100 provides the second user who in this example is a role-play patient with prompt data including a series of pre-determined responses to questions that should be asked by the first user who in this example is role-play medical professional during an assessment. The role-play medical professional is also provided with prompt data such as a scenario and a brief overview of the aliment or condition of the role-play patient. For example, the scenario may relate to the role-play patient having a headache or the like. The prompt data for role-play medical professional may be provided as a window viewable to the role-play medical professional that includes the four categories, in this example, being history, physical examination, investigation, management. The window also include a section for the inputting of notes, including free-form textural notes, in response to answers received from the role-play patient.

The questions asked by the role-play medical professional are indicated at 782 and the pre-determined responses provided to the role-play medical professional by the role-play patient are provided at 284. The questions asked by the role-play medical professional may be entered into a chat window and sent to the role-play patient. This text may also be stored by the system 100.

The role-play patient is provided with the graphical interface shown at 286 with, for example, selectable buttons for which responses have been provided to the role-play medical professional. These responses are stored by the system 100 and processed by process engine two as was described above with reference to FIG. 2b and as is further detailed below. Accordingly, the responses undergo a comparative analysis, at 290, to score the responses in comparison to pre-determined answer data shown at 288. This score data is then incorporated within the results data and are score cards provided by method 300 as is further detailed below.

Any free form or edited pre-determined notes are, at the same time, processed by process engine one using natural language processing as described above with reference to FIG. 2b and as is further detailed below.

Accordingly, in addition to the analysis of notes made by the role-play medical professional, in this example, the role-play patient also makes an assessment of competency of the role-play medical professional by having to interpret the question asked by the role-play medical professional and then select an appropriate response. In particular, this assessment has to ability to identify if a particular questions was not asked or if a response was not provided to the role-play patient and therefore identify shortcomings in the competence of the role-play medical professional. Moreover, as has been described above, the response data provided by role-play patient enables a normalisation to be applied to the results from the natural language processing thereby increasing the accuracy and fairness of the natural language processing.

A more detailed example of the above method as applied to the assessment and training of medical students is now provided below.

### Example Method of Assessment for Medical Students

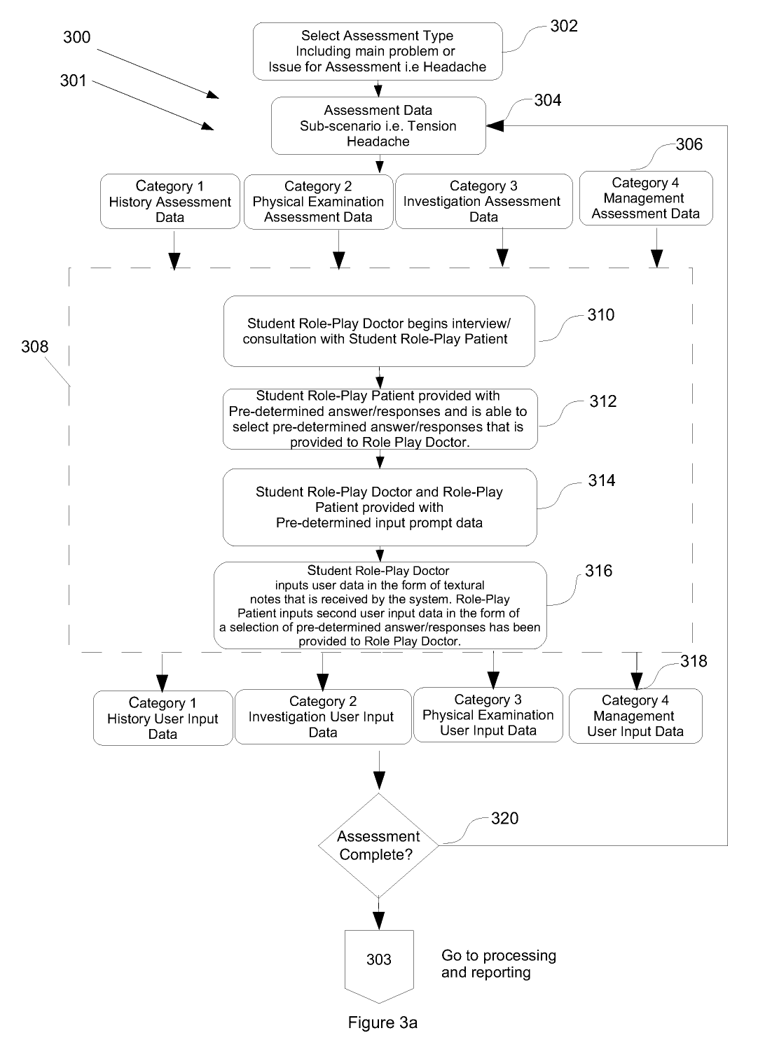

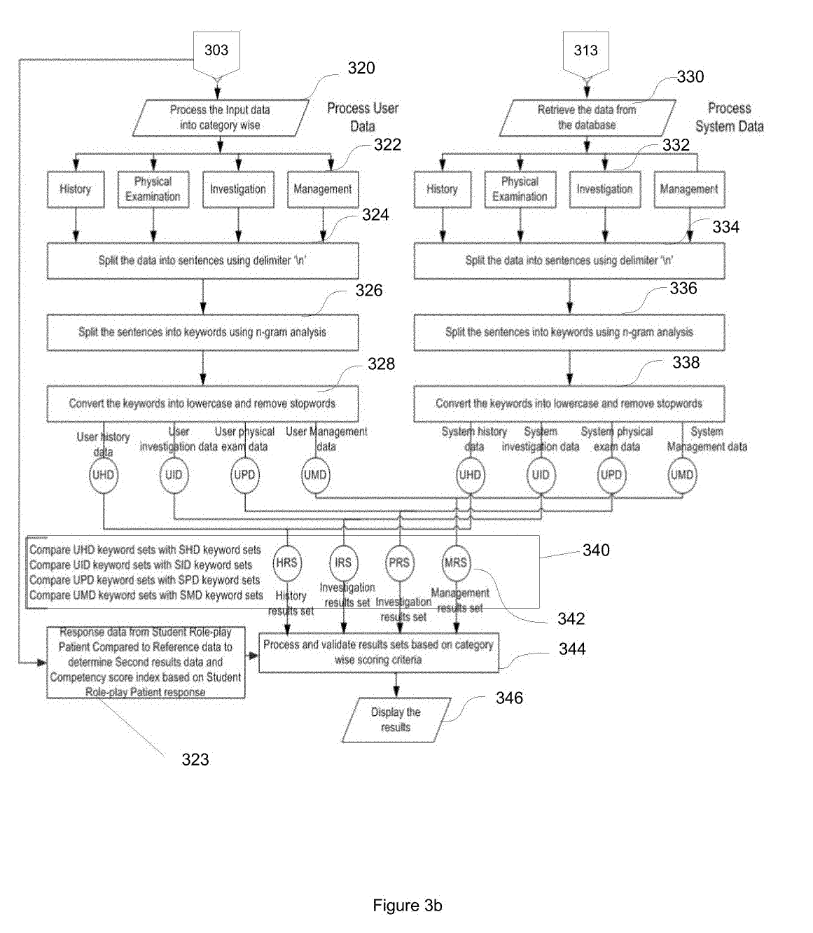

Referring to FIG. 3, there is provided a method 300 including an assessment data collection stage or process 301 followed by a data processing and reporting stage or process 303. These stage are similar to those described above in relation to methods 200, but include further steps specific to medical training. The data collection stage 301 and the data processing and reporting stage or process 303 will be separately described below. It is noted that method 300 is preferably focused, on the assisted method 250b including both an assessment of notes from the first user or role-play medical professional using natural language processing and the response data provided by the second user or role-play patient.

Turning firstly to the information collection stage, 201, at step 302 a general problem, symptom or topic is selected from the server 100. The system 100 or an examiner may then select, at step 304, a case history, sub-problem or scenario associated with the main problem or symptom. There may be six to eight case histories or sub-problems or scenarios associated with the main problem or symptom. For example, in relation the example of the main scenario symptom or problem being a headache, the sub-scenarios may relates to, for example, one of a cluster headache, tension headache, migraine etc. under the main symptom.

These scenarios and the related information include dialogue data including answer data, for the role playing patient, may be stored on the database 114 and communicated via the network 103 to the assessment user or users who receive the assessment data. The dialogue data also includes a series of predetermined responses to questions that should be asked by the role-playing doctor in each category. An example of the dialogue data provided to the role-playing patient is shown in FIG. 2c. It is noted that the dialogue data providing the answers “A” is only provided to the role-playing patient and the role-playing doctor needs to create or think of their own questions “Q” to ask the role-play patient as shown in FIG. 2c. This test the role-play medical professional is sufficiently skilled to ask the correct questions when faced with a particular scenario such as a patient presenting with a headache.

Each of the main symptom scenarios and associated sub-scenarios is also associated with specific categories so as to provide category data at Step 306, which in this example, are shown as History Data, Investigation Data, Investigation Data and Management Data. At Step 308, the assessment is undertaken for each of the Categories 1 to 4, preferably, sequentially.

In this example, at step 308, the assessment may be undertaken in a role-play situation whereby the users including a student role-play medical professional or first user and a student-role play “hypothetical” patient or second user. In this instance, there are two assessment participates with a first person or user being assessed and a second person or user providing pre-determined feedback information from which the first person being assessed bases the user response data. It is noted that the second person may be a computer configured to provide the pre-determined feedback information to questions or prompts asked or entered by the person being assessed. However, in this example, the second user is a student-role play “hypothetical” patient who actively participates in the assessment. The role-play patient provides feedback to the role-play doctor based on a dialogue data provided to the role-play patient. The role-play patient also is provided with a selectable list of responses (shown in FIG. 2c) that have been provided by the roll-play patient to the role-play doctor.

At Step 310, the student role-play medical professional begins interview/consultation with Student Role-Play Patient, and at Step 312, assessment data including pre-determined responses, associated with a case history sub-scenario (shown at Step 306), are provided to the role-play medical professional. The role-play medical professional then bases their input data, which includes free-form textural data, on the pre-determined response from the student-role play patient. The role-play patient also provides input data by making selections from a pre-determined list of the pre-determined responses that have been provided, for example orally or via a chat window, to the role-play medical professional.

Accordingly, at Step 314, the role-play medical professional may be provided with pre-determined input prompt data such as the displaying of a text box, in which user generate text is inputted, on a screen of a local terminal. The role-play patient may also be provided with pre-determined input prompt data, such as a selectable list that relates to the predetermined response data. At Step 316 the user data, from the role-play medical professional, and second user data, from the role-play patient, is inputted and received by the system 100. The user input data and second user input data may be communicated with the server system 102.

Turning now to the assessment data in more detail, the assessment data may include a main or primary problem, symptom or scenarios, for example, a “Headache”. Accordingly, during the assessment, the hypothetical role-play patient presents with a headache but role-play medical professional will need to determine which of the sub-scenarios applies, for example, by determining if the patient has a cluster headache, tension headache or a migraine. The selection of the main symptom may be made by the role playing patient, an Examiner or the like, however, the sub-scenarios may be automatically, preferably randomly selected by the system 100.

Each of the main symptoms and associated scenarios has a pre-determined set of prompts and information that may be provided to the role-playing patient. For example, continuing with the headache example, the role-play medical professional may ask a question, Q: How can I help you, where exactly is your headache?. The role-playing patient may then be provided with assessment data that prompts the response with an answer, A: I have a severe headache in my forehead. The system 100 may then provide input prompt data, at step 314, such as a text box and the user, in this case, the role-play medical professional inputs a free-form textural notes at step 316. The question or assessment data set for tension headache will be specific to this scenario and also be associated or linked via the identifier, in the database 114, to pre-determined reference data against which the user inputted response data is comparatively assessed. The question or assessment data set will also be linked to the pre-determined response data provided to the role-play patient.

The prompts, information, questions or answers may include or lead the role-play medical professional to identify a diagnosis within, preferably, the free-form notes, and importantly, address a set of pre-determined key criteria in the free-form notes. In this example, the predetermined responses provided to the role-play patient include information to allow the role-play doctor to determine the pre-determined key criteria. For example, the role-play patient may have the text “No I am not having a Fever”. When the role-play medical professional asks a question, for example, do you have a fever. The role-play patient selects the pre-determined response text “No I am not having a Fever” and this selection is recorded by the system 100. The role-play medical professional may then make free-form notes, such as, for example, No fever.

The free-form notes may display or include a decision-based keyword preferably indicating an affirmative or negative assessment of the pre-determined key criteria. For example, the pre-determined key criteria associated with a headache may be vomiting and the free-from notes require either a affirmative or negative assessment of vomiting such as “No vomiting” or “Patient vomiting” or the like.

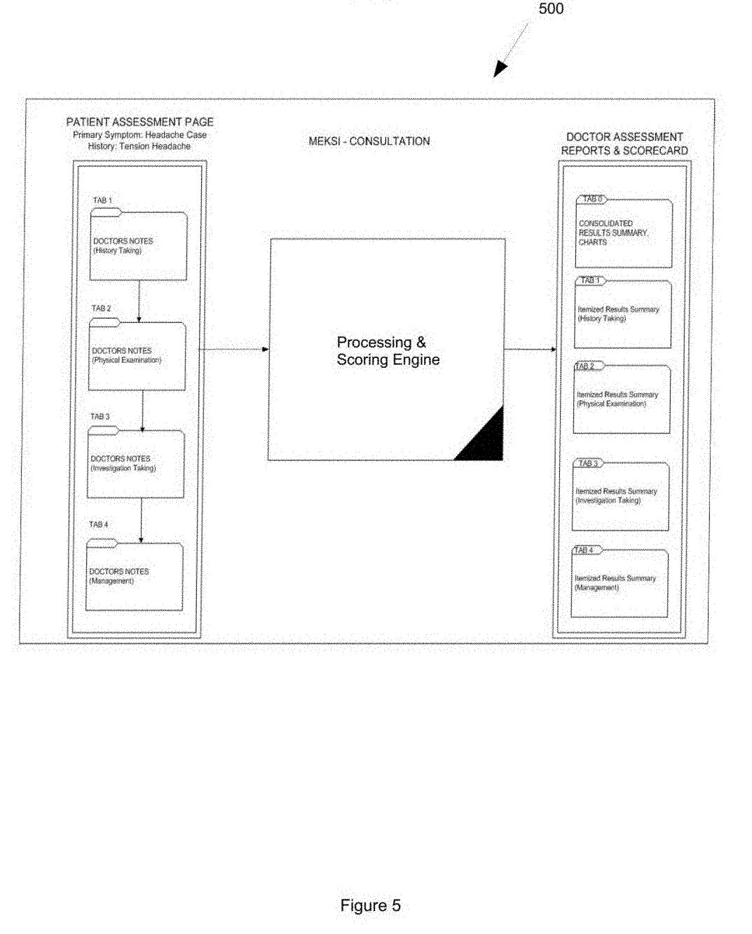

Accordingly, at Step 318, there is provided set of user generated data that includes free-from text that is collated by the system 100 toward or at the end of the assessment process. An example of user input data is provided below and this may be arrange in a consultation environment 500 as shown in FIG. 5. The user generated data may also include the data inputted by the role-play patient as described above and this data may be associated with the user data inputted by the role-play doctor.

### Example User Input Data for the Role-Play Medical Professional

History Taking User Input Data:
   Free Text Notes: No drowsiness, No nausea, No Dizziness, No strange sensations (free text).
Physical Exam User Input Data:
   Free Text Notes: No facial weakness; No arm weakness, No slurring of speech, No increasing frequency;
   Structured response data: including objects like yes/no, dropdown, radio buttons etc, (e.g. body pain y/n while examination?)
Investigations User Input Data:
   Structured response data: Prescribe Investigation like Blood Test, Xray, CT scanfor CT scan, X-ray, blood test etc). This page will have objects like yes/no, dropdown, radio buttons etc.
Management User Input Data:
   Free Text Notes: Prescribe mild analgesics such as aspirin or paracetamol, Prescribe amitriptyline 10-75 mg (oral) note increasing to 150 mg if necessary. Must suggest taking rest/sleep, suggest to do meditation/yoga therapy.
   Structured response data: This page will have object like yes/no, dropdown, radio buttons etc.

As will be further detailed below, the textural analysis will then determine that, firstly the criteria or “Red-flag Symptom” has been identified i.e. “vomiting” or “fever” and then assess that the correct decision such as any affirmative or negative assessment has been made by analysing the text associated with the word “vomiting”. For example, by determining a negative keyword such as “no” in a sentence also containing the word “vomiting”. The criteria or “Red-flag Symptoms” may also be referred to as “priorities”.

Turning now to the processing, scoring and reporting stage. At Step, 320 the user data is now processed and may include a Step 322 separating the user data into the categories of History Data, Investigation Data, Investigation Data and Management Data and performing textural keyword analysis for each of the categories separately. It is noted that whilst one example of textural processing is provided below other types of textural processing (also referring to natural language processing) may also be used.

At Step 324, the textural processing in undertaken by the server system 102 whereby the user input data is split or separated into sentences using, for example, a delimiter “/n”. For example, the free-form history notes many include a series of sentences or statements that relate to one or more questions or information provided to the role-play medical professional. For example, the sentences may start with “No facial weakness, No arm weakness, No slurring of speech”. These would then be separated to Sentence 1: “No facial weakness”, Sentence 2: “No arm weakness”, and Sentence 3: “No slurring of speech”. This may require the user to ensure that appropriate delimiters are used.

At Step 326, the server system 102 then further processes the sentences, and the sentences may then be split into keywords using “n-gram” analysis and at Step 328 the keywords are converted to lower case and the stop words are removed. For example, following on from the above example, the keywords may be: Keywords Sentence 1: “no”, “facial”, “weakness”; Keywords Sentence 2: “no”, “arm”, “weakness”; Keywords Sentence 3: “no”; “slurring” speech”. The processed keyword sets for each sentence and category may then be stored for later further processing or may be immediately further processed by comparison with a pre-determined set of keywords provided as reference data.

At step 323, the data inputted by the role-play patient or second user may also be assessed by comparative database operations. In particular, in this example, the role-play medical professional is penalised (or no positive score is awarded) of the data inputted by the role-play patient indicates that a required question was not asked and as such the associated response was not provided and hence not selected by the role-play patient or second user during the assessment. The comparative database operations may be performed by the processor together with or independently of the textural scoring and may provide a competency index or score.

It is noted that in methods steps 330 to 338 are similar set of data operations may be performed on model or reference answer data to also provide the predetermined set of reference keywords. This allows an examiner, for example, to write one or more model answers that, for consistency, are processed into keywords in accordance with the same method as the user response data being assessed. However, these reference data operations do not need to occur for each related new assessment and in some cases may be omitted and a reference set of keywords may be directly provided, for example, by an examiner may directly entering the keywords expected to be present in the user data. In some examples, the reference data may include response libraries or dictionaries. For example, the dictionary may include short form terms such as “h-ache” or “h'ache” or a user may be able to add these words and the desired meaning to customise the dictionaries (i.e. “h-ache=headache”).

At Step 340, the server system 102, then performs comparative processing operations on the processed user data including the user data keywords are compared to reference data keywords. The reference data may be loaded from the database 114. In a basic example, the reference data for a particular category may include a keyword “arm” and return a match when the user keyword “arm” is matched. This may return a match value of 1 or 100%.

In more complex examples, the comparison algorithm may be set to look for the word “arm” or “weaknesss” (which may be a key criteria word) and then also have related keywords that are to be associated the word “arm”. For example, the word “arm” may have a related reference keyword list such a symptomatic key word and an affirmative or negative keyword that should appear the same sentence {arm*: weak*: no*}. The “*” indicates a Wildcard match. This would allow matching of, for example, the words {arms; weakened; not} (i.e. arms not weekended, or the like). However, other match types such as a related match using a keyword tree or Fuzzy match processes may also be used.

Accordingly, the method 300 may then firstly identify the keyword “Arm” in the user data and then load the related keywords from associated sentence, that in this case, include the words {no; arm; weakness}—this would then return a match value of 1 or 100%. If, for example, the word “no”, “not” etc was missing then perhaps a partial match of, say, 0.6 or 60% may be returned. This process may be repeated for each sentence and each of the keywords to generate a set of results data at Step 342. The results data may also include data from structures responses such as drop down menus, tick a box type responses or the like.

In this example, it is important that the keyword analysis is able to identify a key criteria or “red-flag”, such as “weakness” or “vomiting” and associate this with a decision based, preferably affirmative or negative keyword such as “no”, “not”, “yes”, “present”; “not present” or the like. This allows assessment that these key criteria have been identified by the user and some kind of assessment or decision has been made in relation to the key criteria.

The key criteria are associated with the particular main symptom, a sub-scenario and category. For example, in the situation of the main symptom of the headache having a sub-scenario of a tension headache reference data may include a set of criteria, also referred to herein as “Red Flag Symptoms or flags” that are specific to each of the assessment categories. For example, the associated criteria or red flags for the category of History Taking may include: Vomiting; Fever; Rash; Explosive Onset etc., whilst the category of Physical Examination may include the associated criteria or red flags of: Neck Rigidity, Fever, etc. Each of these keywords may then have a related decision or assessment based keyword.

For example, the key criteria of “vomiting” may be associated decision or assessment based keywords, that preferably are affirmative or negative keywords, such as “not”, no”, “not present” or the like. Accordingly, to achieve a high score the user need to not only identify the criteria keyword, but also, provide the correct assessment such as by inputting a sentence stating, “no vomiting”.

In a more specific example, each key criteria keyword may be stored in the database 114 and will by associated with an assessment category, a scenario and sub-scenario. For example, the criteria keyword=“vomiting” may have an identifier based on the assessment scenario including for example, {Main scenario: Headache; Sub-scenario: Tension Headache; Category: History}. It is noted that alpha-numerical identifiers, such as, {1, 1.1, A} may be typically used where {I=Main scenario: Headache; 1.1=Sub-scenario: Tension Headache; and A=Category: History}.

The criteria keyword=“vomiting” may also form part of a keyword tree including related keywords such as “vomit”, “oral discharge” or the like. The criteria keyword for a particular assessment scenario identifier may also have a decision based keyword associated with the criteria keyword such as “no” being associated with “vomiting”. The decision-based keywords may also be provided in a keyword tree that may include acceptable alternative words such as “not”.

Accordingly, each of the identified sentences, that may itself be assigned a sentence identifier, for example S1, is associated with a particular assessment scenario identifier and the associated pre-determined reference data including the pre-determined keywords. The system 100 then determines if the criteria keyword is present and if the decision-based keyword is present within the specific identified sentence.

This operation may repeat for each identified sentence within the user response data for the particular assessment scenario. For example, for scenario identifier {1,1.1,A}, the pre-determined keywords associated with the scenario identifier {1,1.1,A} may be sequentially compared to each of the sentences {S1, S2 . . . , Sn} whilst at the same time the results data, also to be associated with the scenario identifier {1,1.1, A}, is recorded to indicate keyword match, and in particular, when a criteria keyword and its associated decision based keyword is present.

At Step 344, the results data above is further processed by the system 100 to provide score data for each category and for the overall assessment. The score data may then be provided or display, preferably, as score card such as score card 608 shown in FIG. 6d. Preferably, the assessment will be undertaken separately (for all four categories). Each category is further divided into 3 blocks of questions and each block has the % scores allocated. One of the three blocks of questions requires free-form textual input or notes and these are given a higher weighting. For example, weighting may be applied, in the category of History taking whereby the key criteria or red flag questions block will constitute 80% of weightage and remaining two blocks will have less weightage (remaining 20%). Combined score from all the blocks within the category is added with the (remaining 3 categories) to get the consolidated final score. The score allocation may be configurable.

The score data may also include the competency index or score derived from the role-play patient or second user. The competency index may be include the overall results data as a separate score or combined with the score of the notes to provide an overall assessment score that is provided on the score card.

The scorecard preferably includes consolidated results summary charts and itemised results summaries for each of the four categories. A set of recommendations may also be provided, such as, improvement in physical examination required. These recommendations may be pre-defined and stored on the database 114 and associated with a particular score range, for, example, a score less than 80% displays “Improvement in physical examination required” and may recommend a course or further action such as an upcoming seminar or the like. However, a score over 80% may simply display “Skills appear to be adequate” or the like. An example of the score calculations is provided below in relation to method 600.

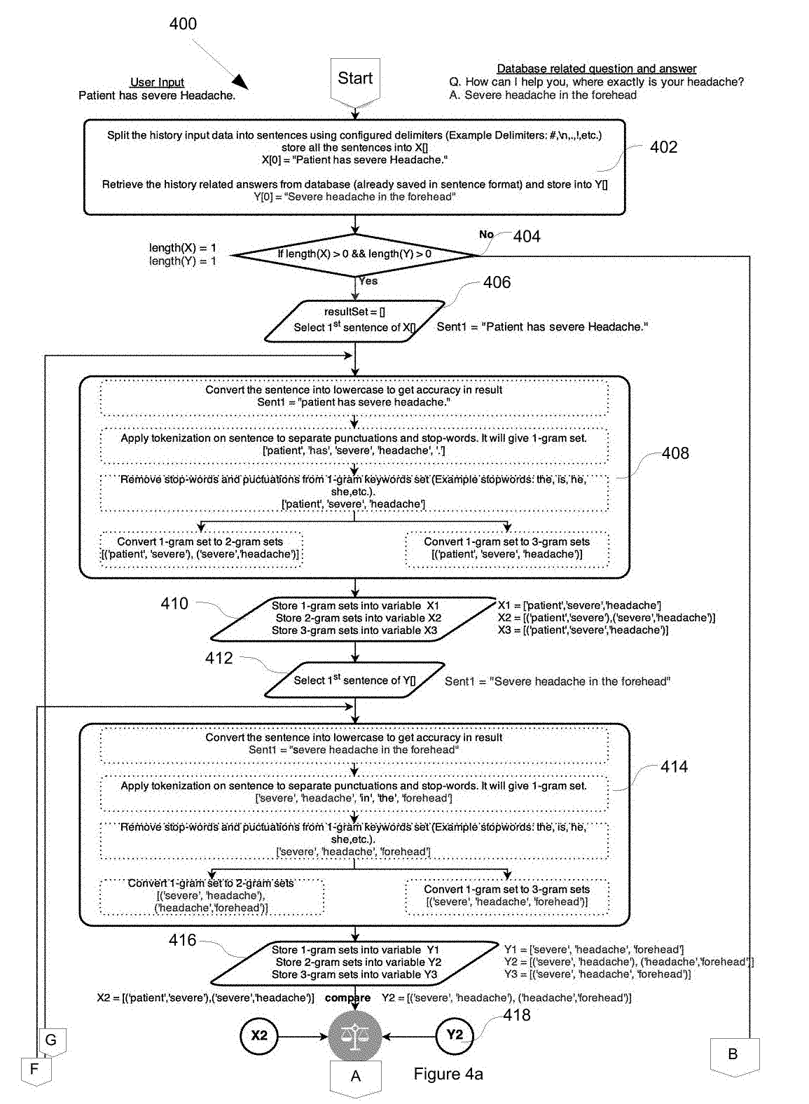

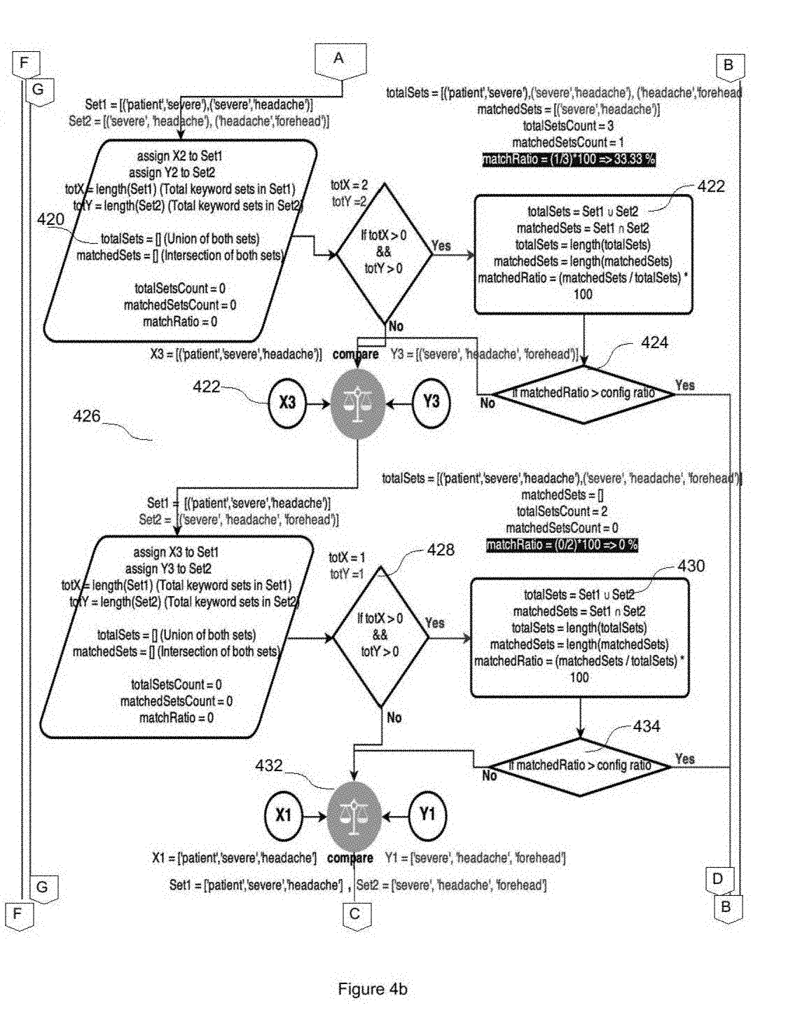

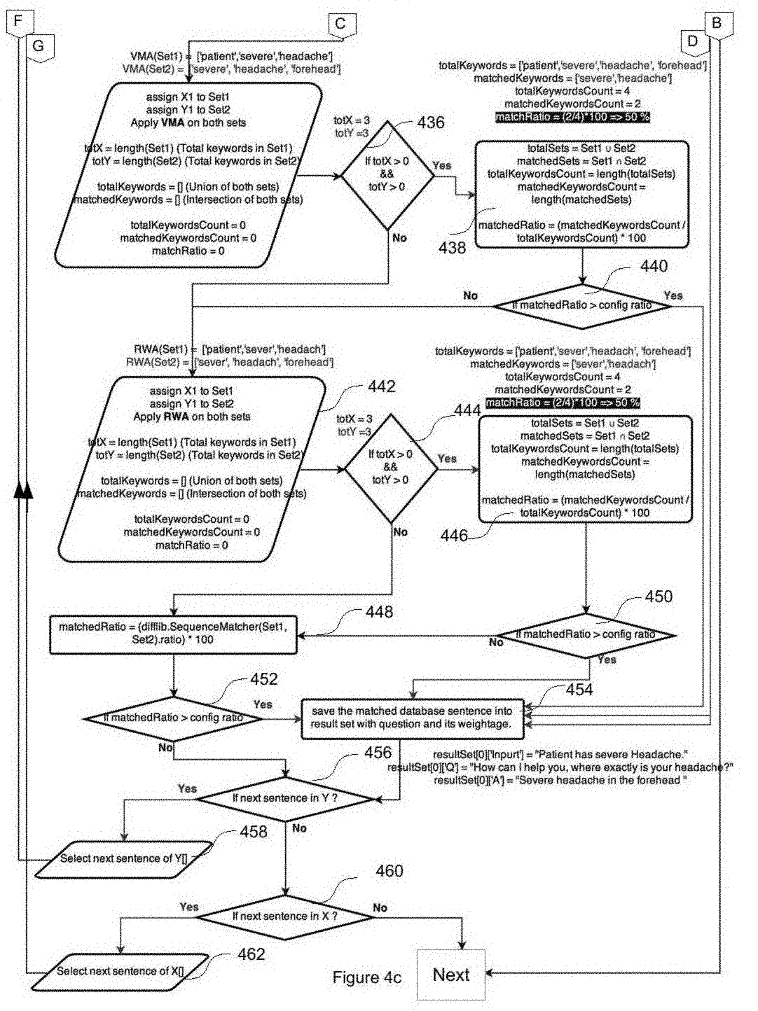

Referring now to FIGS. 4a to 4c, a method 400 of textural analysis is now briefly described. Method 400 may be applied in method 200, 300 and 400, for example, in the data processing and reporting stage or process to analyse the text. FIGS. 4a to 4c include textual descriptions of the method steps as well as example input data, output data, calculations and results. Accordingly, for brevity sake all of text from the FIGS. 4a to 4c is not again repeated here and methods steps are only briefly outlined.

Method 400 is illustrated here in relation to example assessment data that may a user, being a role play doctor, asking a question “Q: How can I help you, where exactly is your headache”. This question may be read by the user to a simulated patient who may be provided, from the assessment data via the database 114, an answer “A: Severe headache in the forehead”. This data is stored as associated reference data on the database 114 that is accessed and read by the application server 122. The user may then provided user textural input data, for example, “UI: Patient has severe Headache”.

Method 400 illustrate the processes by which the comparison is undertaken, by the application server 122, to determine a similarity between, in this case, the answer “A: Severe headache in the forehead” and the user textural input UI: Patient has severe Headache”.

At Step 402, user data and reference or answer data are each split into sentences using delimiters and the sentences are stored in memory 108. At Steps 404 the method determines if both the user input and reference data contain textual data and if so, the method process to Step 408 where n-gram textural processing is performed on a first identified sentence of the user input data. The sentence is converted into 1-gram, 2-gram and 3-gram data sets and stored in memory 108 at Step 410. The 1-gram, 2-gram and 3-gram data sets are assigned the variables X1, X2 and X3, respectively.

At Steps 412 to 416 a similar n-gram process is performed in relation to the first sentence of the reference data to provide the 1 gram, 2-gram and 3-gram data sets that assigned the variables Y1, Y2 and Y3, respectively.

At Steps 418 to Step 436 the method undertakes comparative operations between the identified 1-gram, 2-gram and 3-gram data sets by comparing X1, X2 and X3 with Y1, Y2, and Y3, respectively. At each comparison stage for the 2-gram and 3-gram data, namely Step 418 and 422, the method undertakes a decision Steps at 424, 434 respectively to determine if a suitable match has been made. This includes comparing a determined match ratio with a pre-determined or configuration ratio. If a match is made, the method then proceeds straight to Step 454 when matched data is saved. Accordingly, the methods seeks to find a match using more simplified n-gram keyword matching and only proceeds to more computationally expensive textural processing such as VMA (Vocabulary Morphological Analysis) and RWA Root Word Analysis) as shown in Step 436 and Step 442.

At Step 436, the method employs more VMA analysis between the identified keyword sets and if a suitable match ratio is determined at Step 440 the method proceeds at Step 440 to Step 454. However, if a suitable match is not identified, then the method processed to Step 442 to where RWA textual analysis is performed. Again, if a suitable match ratio is determined at Step 446 the method proceeds at Step 450 to Step 454. If no suitable match has been identified, for the reference date, the method may then move to the next sentence at Steps 456, 458 and 462. If no further sentences are present, at Step 460, the method may end or return to the beginning to process a further dataset. Accordingly, it should be appreciated that the textual analysis include both keyword analyses and more complex phrase and sentence matching using VMA and RWA.

The comparison data is saved at Step 454 to memory 108 or the database 144. The comparison data is then processed into results data loaded by the scoring engine as is now further described below in method 600 with reference to FIGS. 6a to 6c.

Referring now to FIGS. 6a to 6d, a method 600 is provided that illustrates an assessment and scoring methods for utilisation in the above methods 200 and 300. At Step 602, user generated textual input data and pre-determined reference data is processed via textural analysis methods such as that described above in method 400. In this example the data is shown separated in the four categories of History, Investigation, Physical Examination and Management. The textural analysis within each of the categories include a sequence of n-gram analysis being, in the sequence of 2-gram, 3-gram and 1-gram, and then further textural processing include VMA, RMA and sequence matching comparison.

At Step 604, example comparison data is provided that shows the matching between the reference data and user input data for each of the categories. “DB” indicates the reference data as including, for example, key criteria data shown here is as “priority” keywords or sentences. The priority” keywords or sentences may be red flag symptoms. The most important “priority” keywords or sentences may be considered as priority 1 and those with lower priorities being priority 2 and 3, and so forth. The priority 1 priority” keywords or sentences may be given a greater scoring weighting. For example, the History category comparison data includes four “priority 1” keywords and three of the four “priority 1” keywords that been matched under the heading “Matched”.

At Step 606, the scoring engine is now described in further detail. The scoring engine includes processing of the comparison or match data by a processor 106 of the application server 122. In particular, the scoring engine includes placing weightings on the categories and the identification of key criteria. For example, as shown in FIG. 6c, the weighting of the History Category may be 80%, and within the History Category the weighting is higher for the key or “priority” criteria or “red flags” that is in this example 70%.

At Step 608, the respective weightings are multiplied with the comparison data to provide score data that ultimately provides a score for the overall assessment that is indicative of the user's clinical skills. The score data may be split into the categories and the key criteria. The method may also utilise this score data to provide a report based on reporting data that includes tabular outputs such as that shown in FIG. 6d. Such reports may further include recommendations based on each of the scores and overall score and may be provide with further graphs and tables via email, web-interface or printable reports to provide constructive feedback to the user taking the assessment.

In view of the above there has been described an advantageous method for education assessment and in particular in situations that require a person or user, such as a student, listen to information or a participate in a dialogue and make free-form notes from the information. In particular, the methods disclosed herein present information from which a user is required to take notes and may an assessment as to key criteria that relate to a particular main topic, sub-scenario and category.

Advantageously, in some examples, the method employs natural keyword analysis, to enable the comparison of a user inputted response identifying a key criteria or red flag symptoms, and also determining if a decision based keyword, such as affirmative word or negative word is associated with the key criteria. This allows real world assessment to ensure that a user or person is able to take notes that demonstrate that key criteria have been identified and determined to be present or dismissed. Accordingly, the method assists to promote best practice record keeping that is particularly important in the medical profession. The method also provides automated analysis of the results and provides recommendations as to areas of strength and weakness as well as recommended next actions.

Most advantageously, the methods and systems disclosed herein enable assessment of free form textual inputs from a first user such as training role-play professional and also response inputs from a second user such as a role-play patient or examiner. The response inputs from a second user are pre-determined and assist to provide an additional reference points against which the assessment of the free form notes may be normalised or compared. Accordingly, the pre-determined response data from the second user may assist to reduce technical errors and thereby increase the fairness of assessment using natural language processing of free form textural notes. It is also noted that dual assessments methods enable not only the assessment of notes, but also assessment of competency in relation to a training professional leaning to ask the right questions and make the right enquires for any given assessment scenario.

Further advantageously, the methods and systems may be operated between pluralities of first users such as training role-play professionals, and pluralities of second users such as role-play patients and may be operates locally or between remotely located participants. Accordingly, the methods and systems enable mass simultaneous assessment having a consultative environment and enables geographic reach.

Still further advantageously, the above descried method and system offer an additional training tool and perhaps even alterative training tool to the current traditional “OSCE” (Objective Structured Clinical Examination) that is a type of examination often used in health sciences (e.g. medicine, physical therapy, nursing, pharmacy, dentistry etc,). It is designed to test clinical skill performance and competence in skills such as communication, clinical examination, medical procedures/prescription, exercise prescription, joint mobilisation/manipulation techniques, radiographic positioning, radiographic image evaluation and interpretation of results.

The above method and system increases preponderance via state of the art computer implemented methods and systems to exclude key criteria, “priority” or “red flag symptoms” and/or “dangerous conditions” via a negative history.

Further advantages include: gathering evidence of competency is captured by the method and system in the form of instant scoring without any waiting time for results & feedback; Computerized rule engine based scoring is quantified more accurately, eliminating the traditional & OSCE way of subjective assessment, where there is a possibility of subjective prejudice & bias during the scoring process; and the instant reporting mechanism, with inbuilt analytics allows the student to identify the areas of improvement. Accordingly, it is proposed that the method and system described herein would enable a user, such as a medical student, to simulate a far greater number of clinical scenarios than would be possible under the current system. As such, it is envisaged that herein propose method and system that may skill a new generation of medical students that would fit the adage “practice makes perfect”.

Still further advantages of the method and system proposed herein, when applied as a method or system for medical clinical skills assessment, include: Standardize Medical Education: Standardises Medical Teachers and Medical Students in their clinical cases and teaching material; Supervised Mentoring: Helps education to be supervised; Confidence: helps identify candidates for independent clinical practice; Uniformity & Equitable: Focuses on healthcare scenarios being uniform and more equitable for all candidates; Teaching Audit & Progress Tracker: Ability to record, playback, track progress of scores; Recall: Assessment could be re-enabled for repetitive/recall sitting; Re-Certification: Can be used as tool to re-certify skills sets; can be used for continuing medical education/recertification; Ethics: Strong emphasis on ethics; encourages early scrutiny of students' clinical abilities such as empathy, communication, ethics and other RACGP domains.

Whilst the above examples have been primary described in relation to training and assessment of a medical student, it is noted that the methods may equally be applicable to other fields and professions such as law, engineering and business.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any known matter or any prior publication is not, and should not be taken to be, an acknowledgment or admission or suggestion that the known matter or prior art publication forms part of the common general knowledge in the field to which this specification relates.

While specific examples of the invention have been described, it will be understood that the invention extends to alternative combinations of the features disclosed or evident from the disclosure provided herein.

Many and various modifications will be apparent to those skilled in the art without departing from the scope of the invention disclosed or evident from the disclosure provided herein.

The claims defining the Invention are as follows:

1. A computer implemented method for educational assessment of a first user using textural input data associated with the first user and response data provided by a second user in response to a pre-determined assessment, the method including the steps of:
Receiving, via a computer system, textural input data associated with the first M user in relation to the pre-determined assessment,
Receiving, via the computer system, response data from the second user in relation to the pre-determined assessment,
Processing, via the computer system, the textural input data to determine a set of textural features and comparing the set of textural features with a set of pre-determined textural features associated with the pre-determined assessment so as to provide textural comparison data;
Processing, via the computer system, the response data by comparing the response data with pre-determined response reference data associated with the pre-determined assessment so as to provide response comparison data;
Calculating, via the computer system, first results data indicating the similarity of the textual features and the pre-determined textural features based on the textural comparison data, and calculating second results data indicating the similarity of the response data and the pre-determined response reference data; and
Providing, via the computer system, score data configured to indicate the at least one of the first results data, the second results data and a combination of the first and second results data.

2. The computer implemented method according to claim 1, wherein the method includes the steps of:
Providing, via the computer system, first assessment prompt data to the first user in relation to the pre-determined assessment, and
Providing, via the computer system, second assessment prompt data to the second user associated with the pre-determined assessment, and
wherein the first assessment prompt data includes a pre-determined assessment scenario upon which the first user is able to base questions communicable with the second user, and
wherein the second assessment prompt data includes a series of answers associated with the pre-determined assessment scenario, the series of answers being selectable by the second user in response to the questions of the first user so as to provide the response data, and
wherein textural input data is provided by at least one of user inputted text by the first user in response to the series of answers, predetermined text associated with the series of answers of the response data and a combination of user inputted text and the predetermined text.

3. The computer implemented method according to claim 1, wherein the method further includes the steps of:
Processing, via the computer system, the textural features to identify one or more sentences and keywords associated with each of the one or more sentences, and
Comparing, via the computer system, the keywords associated with each of the one or more sentences with one or more pre-determined main criteria keywords and associated one or more pre-determined decision based keywords to determine similarity data indicative of the presence of the one or more pre-determined main criteria keywords and the associated one or more of the pre-determined decision based keywords in the identified one or more sentences;
Calculating, via the computer system, the first results data based on the similarity data.

4. A computer system for educational assessment of a first user using textural input data associated with the first user and response data provided by a second user in response to a pre-determined assessment, the computer system being configurable to:
Receive, via the computer system, textural input data associated with the first user in relation to the pre-determined assessment,
Receive, via the computer system, response data from the second user in relation to the pre-determined assessment,
Process, via the computer system, the textural input data to determine a set of textural features and comparing the set of textural features with a set of pre-determined textural features associated with the pre-determined assessment so as to provide textural comparison data;
Process, via the computer system, the response data by comparing the response data with pre-determined response reference data associated with the pre-determined assessment so as to provide response comparison data;
Calculate, via the computer system, first results data indicating the similarity of the textual features and the pre-determined textural features based on the textural comparison data, and calculating second results data indicating the similarity of the response data and the pre-determined response reference data; and
Provide, via the computer system, score data configured to indicate at least one of the first results data, the second results data and a combination of the first and second results data.

5. A computer implemented method for educational assessment of user generated textural input data provided in response to a pre-determined assessment, the method including the steps of:
Receiving, via the computer system, the user generated textural input data in relation to the pre-determined assessment;
Processing, via the computer system, the user generated textural input data to identify sentences and keywords associated with the identified sentences;
Comparing, via the computer system, the keywords associated with each identified sentences with one or more main criteria keywords and one or more decision based keywords associated with the one or more main criteria keywords so as to determine similarity data indicative the presence of the one or more pre-determined main criteria keywords and the associated one or more pre-determined decision based keywords in each of the identified sentences, the one or more pre-determined main criteria keywords and one or more pre-determined decision based keywords being loaded from predetermined reference data; and
Calculating, via the computer system, results data based on the similarity data indicating a similarity between the user generated textural input data and the predetermined reference data.
